(19) United States
(12) Patent Application Publication
(10) Pub. No.: US 2015/0343642 A1
(43) Pub. Date: Dec. 3, 2015

(54) ROBOT, ROBOT SYSTEM, AND CONTROL METHOD

(71) Applicant: Seiko Epson Corporation, Tokyo (JP)

(72) Inventors: Yuki KIYOSAWA, Matsumoto (JP); Kenichi MARUYAMA, Tatsuno (JP)

(21) Appl. No.: 14/725,478

(22) Filed: May 29, 2015

(30) Foreign Application Priority Data
Jun. 2, 2014 (JP) 2014-114286

(51) Int. Cl. B25J 9/16

(52) U.S. Cl. CPC B25J 9/1697; Y10S 901/02; Y10S 901/47

(57) ABSTRACT

A robot includes: hands; and a control unit which controls the hands, in which the control unit grasps a target to be grasped by using the hands and detects a position of the target to be grasped, based on a captured image including the target to be grasped.

### BACKGROUND

1. Technical Field

The present invention relates to a robot, a robot system, a control device, and a control method.

2. Related Art

A technology of causing a robot to perform an operation using a tool has been investigated and developed.

A technology of directly connecting an end effector as the tool, to an arm of the robot has been proposed (see JP-A-2012-35391) .

However, in the robot of the related art, in a case where a target to be grasped is grasped by a hand, it is difficult to ascertain a predetermined grasping position of the target to be grasped due to an error generated at the time of grasping, in some cases, and as a result, an error is generated in a relative position between the hand and the predetermined position of the target to be grasped, and the operation relating to the target to be grasped may fail. In addition, in the robot of the related art, the error described above may affect the operation performed using the target to be grasped, due to the failure described above.

More specifically, when grasping a driver, for example, if the robot of the related art grasps the driver at a position deviated from the predetermined grasping position, fitting of a screw may fail when fitting the screw as an operation member using the tip of the driver and tightening the fit screw at a predetermined position.

### SUMMARY

An advantage of some aspects of the invention is to provide a robot, a robot system, a control device, and a control method which can determine success or failure regarding the grasping of a target to be grasped.

An aspect of the invention is directed to a robot including: hands; and a control unit which controls the hands, in which the control unit grasps a target to be grasped by using the hands and detects a position of the target to be grasped, based on a captured image including the target to be grasped.

With this configuration, the robot grasps the target to be grasped by using the hands and detects the position of the target to be grasped, based on the captured image including the target to be grasped. Accordingly, the robot can determine success or failure of the grasping of the target to be grasped.

In another aspect of the invention, in the robot, the control unit may perform a position state determination process for determining whether or not a position state showing a relative position between the position of the target to be grasped and the position of a hand is a predetermined position state, based on the detected position of the target to be grasped.

With this configuration, the robot determines whether or not a position state showing a relative position between the position of the target to be grasped and the position of the hand is a predetermined position state, based on the detected position of the target to be grasped. Accordingly, the robot can realize the operation performed according to the position state.

In another aspect of the invention, in the robot, the control unit may fit an operation member to the target to be grasped and determine a fitting state of the operation member based on a captured image including the operation member.

With this configuration, the robot fits the operation member to the target to be grasped and determines the fitting state of the operation member based on the captured image including the operation member. Accordingly, the robot can realize the operation performed according to the fitting state of the operation member.

In another aspect of the invention, in the robot, the control unit may perform the fitting and determine the fitting state, when it is determined that the position state is the predetermined position state.

With this configuration, the robot fits the operation member to the target to be grasped and determines the fitting state, when it is determined that the position state is the predetermined position state. Accordingly, the robot can perform the fitting as the next operation, while preventing errors from occurring when grasping the target to be grasped, for example.

In another aspect of the invention, in the robot, the control unit may perform the fitting and determine the fitting state, when it is determined that the position state is not the predetermined position state and it is determined that the deviation from the predetermined position state is in a predetermined range.

With this configuration, the robot fits an operation member to the target to be grasped and determines the fitting state, when it is determined that the position state is not the predetermined position state and it is determined that the deviation from the predetermined position state is in a predetermined range. Accordingly, the robot can perform the fitting as the next operation, while suppressing the range of the errors occurring when grasping the target to be grasped, in a predetermined range, for example.

In another aspect of the invention, in the robot, the control unit may grasp the target to be grasped, again, when it is determined that the position state is not the predetermined position state and it is determined that the deviation from the predetermined position state is not in a predetermined range.

With this configuration, the robot grasps the target to be grasped, again, when it is determined that the position state is not the predetermined position state and it is determined that the deviation from the predetermined position state is not in a predetermined range. Accordingly, the robot can perform the fitting as the next operation, after grasping the target to be grasped, again, when the error occurring when grasping the target to be grasped is great, for example.

In another aspect of the invention, in the robot, the control unit may determine whether or not the operation member is fit in the predetermined fitting state.

With this configuration, the robot determines whether or not the operation member is fit in the predetermined fitting state. Accordingly, the robot can perform different operations in a case where the operation member is fit in the predetermined fitting state and a case where the operation member is not fit in the predetermined fitting state.

In another aspect of the invention, in the robot, the operation member may be magnetically attached to a tip of the target to be grasped by a magnetic force.

With this configuration, the operation member is fit to the tip of the target to be grasped by a magnetic force on the tip of the target to be grasped, and determines the fitting state thereof. Accordingly, the robot can perform the operation according to the fitting state of the operation member by a magnetic force on the tip of the target to be grasped.

In another aspect of the invention, in the robot, the control unit may determine the fitting state of the operation member based on a captured image obtained by performing the imaging in each direction from two or more directions.

With this configuration, the robot determines the fitting state of the operation member based on the captured image obtained by performing the imaging in each direction from two or more directions. Accordingly, the robot can prevent erroneous determination of the fitting state of the operation member.

In another aspect of the invention, in the robot, the control unit may determine the position state of the target to be grasped, based on the captured image by pattern matching.

With this configuration, the robot determines the position state of the target to be grasped, based on the captured image by the pattern matching. Accordingly, the robot can determine the position state of the grasping target using pattern matching.

In another aspect of the invention, in the robot, the control unit may determine the fitting state of the operation member based on the captured image by pattern matching.

With this configuration, the robot determines the fitting state of the operation member based on the captured image by pattern matching. Accordingly, the robot can determine the fitting state of the operation member using pattern matching.

In another aspect of the invention, in the robot, the control unit may move the hand according to the result of determination of the position state.

With this configuration, the robot moves the hand according to the result of determination of the position state. Accordingly, the robot can realize the operation of the hand according to the position state of the target to be grasped.

In another aspect of the invention, in the robot, the control unit may move the hand according to the result of determination of the fitting state.

With this configuration, the robot moves the hand according to the result of determination of the fitting state of the operation member. Accordingly, the robot can realize the operation of the hand according to the fitting state of the operation member.

In another aspect of the invention, in the robot, the control unit may stop the operation of the hand, when it is determined that the operation member is not fit in the predetermined fitting state.

With this configuration, the robot stops the operation of the hand, when it is determined that the operation member is not fit in the predetermined fitting state. Accordingly, in the robot, it is not necessary for a user to stop the operation of the hand, even when the fitting of the operation member fails.

Still another aspect of the invention is directed to a robot system including: a robot including hands grasping a target to be grasped; and an imaging unit which captures a captured image including the target to be grasped, in which the robot grasps the target to be grasped by a hand and detects a position of the target to be grasped based on the captured image including the target to be grasped.

In the robot system, the robot grasps the target to be grasped by using the hand and detects a position of the target to be grasped based on the captured image including the target to be grasped. Accordingly, the robot system can determine success or failure of the grasping of the target to be grasped.

Yet another aspect of the invention is directed to a control device which operates a robot including hands grasping a target to be grasped, in which the control device causes the robot to grasp the target to be grasped by a hand, and detects the position of the target to be grasped based on a captured image including the target to be grasped.

With this configuration, the control device causes the robot to grasp the target to be grasped by using the hand, and detects the position of the target to be grasped based on a captured image including the target to be grasped. Accordingly, the control device can determine success or failure of the grasping of the target to be grasped.

Still yet another aspect of the invention is directed to a control method of causing a robot including hands grasping a target to be grasped, to: grasp the target to be grasped by a hand and detect a position of the target to be grasped based on a captured image including the target to be grasped.

With this configuration, the control method causes the robot to grasp the target to be grasped by using the hand and detect a position of the target to be grasped based on a captured image including the target to be grasped. Accordingly, the control method can determine success or failure of the grasping of the target to be grasped.

According to the configurations, the robot, the robot system, the control device, and the control method grasp the target to be grasped by using the hand and detect the position of the target to be grasped based on the captured image including the target to be grasped. Thus, the robot can determine success or failure of grasping of the target to be grasped.

### BRIEF DESCRIPTION OF THE DRAWINGS

The invention will be described with reference to the accompanying drawings, wherein like numbers reference like elements.

FIG. 1 is a diagram showing a configuration of a robot system according to the embodiment.

FIG. 2 is a diagram showing an example of a state where a second movingly-captured image is obtained by performing the imaging by a second movable imaging unit.

FIG. 3 is a diagram showing an example of a hardware configuration of a control device.

FIG. 4 is a diagram showing an example of a functional configuration of the control device.

FIG. 5 is a flowchart showing a flow from a process in which the control device causes the robot to grasp an electric driver to a process of performing an operation based on a determination result showing whether or not a fitting error has occurred.

FIGS. 6A to 6C are diagrams showing examples of a state where the fitting error has not occurred and a state where the fitting error has occurred.

### DESCRIPTION OF EXEMPLARY EMBODIMENTS

### Embodiment

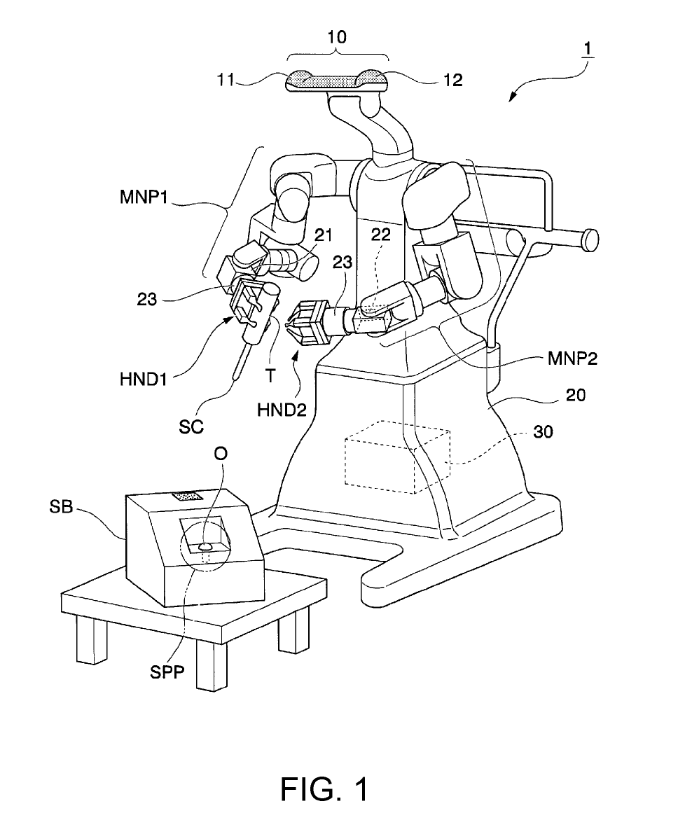

Hereinafter, embodiments of the invention will be described with reference to the drawings. FIG. 1 is a diagram showing a configuration of a robot system 1 according to the embodiment. The robot system 1 includes a robot 20 including four imaging units (a first fixed imaging unit 11, a second fixed imaging unit 12, a first movable imaging unit 21, and a second movable imaging unit 22), and a control device 30.

The robot system 1 images a range for the robot 20 to perform operations, by the first fixed imaging unit 11 and the second fixed imaging unit 12. Herein, the robot system 1 performs the imaging by the first fixed imaging unit 11 and the second fixed imaging unit 12. In the robot system 1, a first object and a second object which is assembled to the first object by screwing are disposed to be overlapped with each other by the robot 20, based on a captured image which is obtained by performing the imaging by the first fixed imaging unit 11 and the second fixed imaging unit 12. At the time of performing this disposition, the robot system 1 disposes a jig (in an example shown in FIG. 1, a table-shaped jig) so that a screw hole of the first object and a screw hole of the second object coincide with each other when these are seen from the top of the screw hole. Hereinafter, the positions of the screw holes at this time will be described by being collectively referred to as predetermined screw fastening positions.

After the first object and the second object are disposed on the jig, the robot system 1 detects a position where an electric driver T is installed, from the captured image which is obtained by performing the imaging by the first fixed imaging unit 11 and the second fixed imaging unit 12, and causes the robot 20 to grasp the electric driver T based on the detected position. After causing the robot 20 to grasp the electric driver T, the robot system 1 detects a predetermined position (hereinafter, referred to as a position of a grasping unit) on a grasping unit (any one of a grasping unit HND1 or a grasping unit HND2 grasping the electric driver T) and a position of a tip SC of the electric driver T based on any one of a captured image which is obtained by performing the imaging by the first movable imaging unit 21 and a captured image which is obtained by performing the imaging by the second movable imaging unit 22.

The robot system 1 determines whether or not a state of a relative position between the position of the grasping unit and the position of the tip SC of the electric driver T (hereinafter, referred to as a position state of the electric driver T) is a position state where a appropriate relative position is realized (hereinafter, referred to as a appropriate position state). The appropriate relative position is a relative position between a position of the grasping unit HND1 or the grasping unit HND2 grasping the electric driver T and the position of the tip SC of the electric driver T, and is a relative position which is realized by one of the grasping unit HND1 and the grasping unit HND2 grasping the electric driver T when the electric driver T is grasped at the predetermined grasping position.

When it is determined that the position state of the electric driver T is the appropriate position state, the robot system 1 supplies a screw O from a material supply device SB to the tip SC of the electric driver T by the electric driver T grasped by the robot 20. Herein, supplying of the screw to the tip SC of the electric driver T means to adsorb the screw O to the tip SC of the electric driver T. Specifically, supplying of the screw O to the tip SC of the electric driver T means various states which are applied in well-known technology, such as to magnetically attaching the screw O to the tip SC of the electric driver T or to adsorb the screw O to the tip SC of the electric driver T using air. In the embodiment, magnetically attaching the screw O to the tip SC of the electric driver T will be described as an example. Hereinafter, magnetically attaching of the screw O to the tip SC of the electric driver Twill be described by being referred to as the fitting of the screw O to the tip SC of the electric driver T.

When it is determined that the position state of the electric driver T is not an appropriate position state, the robot system 1 determines whether or not a difference between the relative position between the positions of the tip SC of the electric driver T and the grasping unit when the position state of the electric driver T is the appropriate position state (hereinafter, referred to as a appropriate position), and the relative position between the positions of the tip SC of the electric driver T and the grasping unit in the current position state (hereinafter, referred to as an inappropriate position) is in a predetermined range.

As a result of the determination, when it is determined that a difference between the appropriate position and an inappropriate position is in a predetermined range, the robot system 1 fits the screw O to the tip SC of the electric driver T from the material supply device SB by the electric driver T grasped by the robot 20. Meanwhile, as the result of the determination, when it is determined that a difference between the appropriate position and the inappropriate position is not in a predetermined range, the robot system causes the robot 20 to perform a predetermined operation. The predetermined operation is an operation such as returning the electric driver T to an initial position and grasping the electric driver T again or an operation of stopping the operation of the robot 20, for example. Hereinafter, for convenience of description, the predetermined operation will be described as an operation of returning the electric driver T to the initial position and grasping the electric driver T again. The material supply device SB is a device which disposes the screw O accommodated therein to a position SPP each time when the screw O is removed from the position SPP shown in FIG. 1.

After the screw O is fit to the tip SC of the electric driver T, the robot system 1 determines whether or not the state of the screw O fit to the tip SC of the electric driver T (hereinafter, referred to as a fitting state) is a appropriate state based on any one of a captured image which is obtained by performing the imaging by the first movable imaging unit 21 and a captured image which is obtained by performing the imaging by the second movable imaging unit 22.

The appropriate state is, for example, a state in which a tip of the tip SC of the electric driver T is inserted into a recess provided on a screw head of the screw O and a center axis of the electric driver T extending in a longitudinal direction and a center axis extending in a direction in which the screw O travels by screw fastening coincide with each other, and accordingly the screw O can be fastened by the electric driver T. However, there is no limitation and any states may be used. The state after the screw O is fit to the tip SC of the electric driver T including the appropriate state is an example of the fitting state. In addition, the appropriate state is an example of a predetermined state.

As a result of the determination, when it is determined that the screw O is not fit in the appropriate state (fitting error), the robot system 1 performs an operation based on the fitting error. The operation based on the fitting error is such an operation of moving the electric driver T to a predetermined standby position and stopping the electric driver or an operation of removing the screw O from the electric driver T and fitting the screw O to the electric driver from the material supply device SB again. Meanwhile, as a result of the determination, when it is determined that the screw O is fit in the appropriate state, the robot system 1, moves the screw O fit to the electric driver T to the predetermined screw fastening position and performs the screw fastening, for example. Hereinafter, an operation performed by the robot system 1 after the first object and the second object are disposed to be overlapped with each other by the robot 20 will be described.

In the robot system 1, a configuration in which the robot 20 grasps the electric driver T is used, but instead of this, the robot may grasp any other tools usable by a person or any other tools dedicated for the robot. The tools usable by a person are a ratchet handle, a spanner, and the like, for example. In a case where the tool is a ratchet handle, the member to be fit is a ratchet socket, instead of the screw O, and in a case where the tool is a spanner, the member to be fit is a bolt or a nut, instead of the screw O. A tool dedicated for the robot is an electric driver provided in a manipulator of the robot as an end effector, and the like. The electric driver T (that is, the tool) is an example of a target to be grasped. In addition, the screw O (that is, the member to be fit) is an example of an operation member.

The robot 20 is a double arm robot including an imaging unit 10, the first movable imaging unit 21, the second movable imaging unit 22, a force sensor 23, the grasping unit HND1, the grasping unit HND2, a manipulator MNP1, a manipulator MNP2, and a plurality of actuators (not shown). The double arm robot indicates a robot including two arms which are an arm configured with the grasping unit HND1 and the manipulator MNP1 (hereinafter, referred to as a first arm) and an arm configured with the grasping unit HND2 and the manipulator MNP2 (hereinafter, referred to as a second arm).

The robot 20 may be a single arm robot, instead of a double arm robot. A single arm robot indicates a robot including one arm and, for example, indicates a robot including any one of the first arm and the second arm. The robot 20 further includes the control device 30 embedded therein and is controlled by the embedded control device 30. The robot 20 may be controlled by the externally-installed control device 30, instead of using the configuration of an embedded control device 30.

The first arm is a six-axial vertical articulated type. A support table, the manipulator MNP1, and the grasping unit HND1 can perform an operation having degrees of freedom in six axes by a joint operation by the actuators. The first arm includes the first movable imaging unit 21 and the force sensor 23.

The first movable imaging unit 21 is, for example, a camera including a charge coupled device (CCD) or a complementary metal oxide semiconductor (CMOS) which is an imaging device converting condensed light into an electric signal.

The first movable imaging unit 21 is connected to the control device 30 through a cable to communicate with the control device. Wired communication through the cable is performed based on standards such as Ethernet (registered trademark) or universal serial bus (USB), for example. The first movable imaging unit 21 and the control device 30 may be connected to each other through wireless communication performed based on communication standards such as Wi-Fi (registered trademark).

As shown in FIG. 1, the first movable imaging unit 21 is included in a part of the manipulator MNP1 configuring the first arm and can be moved by the movement of the first arm. When the electric driver T is grasped by the grasping unit HND2, the first movable imaging unit 21 captures a still image of a range including the grasping unit HND2 and the electric driver T grasped by the grasping unit HND2 as a first movingly-captured image. When the electric driver T is grasped by the grasping unit HND2, the first movable imaging unit 21 captures a still image of a range including the electric driver T grasped by the grasping unit HND2 and the screw O fit to the tip SC of the electric driver T as the first movingly-captured image. The first movable imaging unit 21 is configured to capture the still image as the first movingly-captured image, but may be configured to capture a moving image as the first movingly-captured image.

The force sensor 23 included in the first arm is included between the grasping unit HND1 and the manipulator MNP1 of the first arm. The force sensor 23 detects a force or a moment operating on the grasping unit HND1 (or the electric driver T grasped by the grasping unit HND1). The force sensor 23 outputs information regarding the detected force or moment to the control device 30 through communication. The information regarding the force or moment detected by the force sensor 23 is, for example, used in impedance control of the robot 20 by the control device 30.

The second arm is a six-axial vertical articulated type. A support table, the manipulator MNP2, and the grasping unit HND2 can perform an operation having degrees of freedom in six axes by a joint operation by the actuators. The second arm includes the second movable imaging unit 22 and the force sensor 23.

The second movable imaging unit 22 is, for example, a camera including a CCD or a CMOS which is an imaging device converting condensed light into an electric signal.

The second movable imaging unit 22 is connected to the control device 30 through a cable to communicate with the control device. Wired communication through the cable is performed based on standards such as Ethernet (registered trademark) or USB, for example. The second movable imaging unit 22 and the control device 30 may be connected to each other through wireless communication performed based on communication standards such as Wi-Fi (registered trademark).

As shown in FIG. 1, the second movable imaging unit 22 is included in a part of the manipulator MNP2 configuring the second arm and can be moved by the movement of the second arm. When the electric driver T is grasped by the grasping unit HND1, the second movable imaging unit 22 captures a still image of a range including the grasping unit HND1 and the electric driver T grasped by the grasping unit HND1 as a second movingly-captured image. When the electric driver T is grasped by the grasping unit HND1, the second movable imaging unit 22 captures a still image of a range including the electric driver T grasped by the grasping unit HND1 and the screw O fit to the tip SC of the electric driver T as the second movingly-captured image. The second movable imaging unit 22 is configured to capture the still image as the second movingly-captured image, but may be configured to capture a moving image as the second movingly-captured image. The second movingly-captured image is an example of the captured image.

The force sensor 23 included in the second arm is included between the grasping unit HND2 and the manipulator MNP2 of the second arm. The force sensor 23 detects a force or a moment operating on the grasping unit HND2 (or the electric driver T grasped by the grasping unit HND2). The force sensor 23 outputs information regarding the detected force or moment to the control device 30 through the communication. The information regarding the force or moment detected by the force sensor 23 is, for example, used in compliant motion control of the robot 20 by the control device 30.

Each of the first arm and the second arm may perform an operation with five or less degrees of freedom (five axes) or may perform an operation with seven or more degrees of freedom (seven axes). Hereinafter, an operation of the robot 20 performed by the first arm and the second arm will be described. The grasping unit HND1 and the grasping unit HND2 of the robot 20 respectively include claw portions which can grasp an object. Accordingly, the robot 20 can grasp the electric driver T by one or both of the grasping unit HND1 and the grasping unit HND2.

The imaging unit 10 includes the first fixed imaging unit 11 and the second fixed imaging unit 12 and is a stereo imaging unit configured with the two imaging units. Instead of being configured with the two imaging units, the imaging unit 10 may be configured with three or more imaging units, or may capture a two-dimensional image with one camera. In the embodiment, as shown in FIG. 1, the imaging unit 10 is installed on a head portion of the robot 20 as a part of the robot 20, but instead of this, the imaging unit may be configured to be installed at a position different from the robot 20 as a separate body from the robot 20.

The first fixed imaging unit 11 is, for example, a camera including a CCD or a CMOS which is an imaging device converting condensed light into an electric signal. The first fixed imaging unit 11 is connected to the control device 30 through a cable to communicate with the control device. Wired communication through the cable is performed based on standards such as Ethernet (registered trademark) or USB, for example. The first fixed imaging unit 11 and the control device 30 may be connected to each other through wireless communication performed based on communication standards such as Wi-Fi (registered trademark).

The first fixed imaging unit 11 is installed in a position where the range including the material supply device SB (hereinafter, referred to as an operation area) can be imaged as a range in which the robot 20 performs an operation. Hereinafter, a still image captured by the first fixed imaging unit 11 will be described by being referred to as a first fixedly-captured image. The first fixed imaging unit 11 has a configuration of capturing the still image as the first fixedly-captured image, but instead of this, the first fixed imaging unit may have a configuration of capturing a moving image as the first fixedly-captured image.

The second fixed imaging unit 12 is, for example, a camera including a CCD or a CMOS which is an imaging device converting condensed light into an electric signal. The second fixed imaging unit 12 is connected to the control device 30 through a cable to communicate with the control device. Wired communication through the cable is performed based on standards such as Ethernet (registered trademark) or USB, for example. The second fixed imaging unit 12 and the control device 30 may be connected to each other through wireless communication performed based on communication standards such as Wi-Fi (registered trademark).

The second fixed imaging unit 12 is installed in a position where the operation range which is the same as that of the first fixed imaging unit 11 (operation area) can be imaged. Hereinafter, the still image captured by the second fixed imaging unit 12 will be described by being referred to as the second fixedly-captured image. The second fixed imaging unit 12 has a configuration of capturing a still image as the second fixedly-captured image, but instead of this, the second fixed imaging unit may have a configuration of capturing a moving image as the second fixedly-captured image. Hereinafter, for convenience of description, the first fixedly-captured image and the second fixedly-captured image will be described by being collectively referred to as a stereo captured image.

The robot 20 is connected to the control device 30 embedded in the robot 20 through a cable to communicate with the control device. Wired communication through the cable is performed based on standards such as Ethernet (registered trademark) or USB, for example. The robot 20 and the control device 30 may be connected to each other through wireless communication performed based on communication standards such as Wi-Fi (registered trademark).

In the embodiment, the robot 20 having a configuration of acquiring a control signal from the control device 30 embedded in the robot 20 and fitting the screw O from the material supply device SB to the electric driver T grasped by the grasping unit HND1 of the robot 20, based on the acquired control signal, will be described. When the fitting of the screw O to the electric driver T is failed, the robot 20 performs the operation based on the fitting error described above.

In the following description, the operation performed by the first arm may be performed by the second arm and the operation performed by the second arm may be performed by the first arm. That is, the robot 20 may have a configuration in which the electric driver T is grasped by the grasping unit HND2, instead of a configuration in which the electric driver T is grasped by the grasping unit HND1. In this case, the operations performed by the first arm and the second arm are switched in the following description.

The control device 30 detects the position where the electric driver T is installed based on the stereo captured image obtained by imaging the operation area by the imaging unit 10 and causes the grasping unit HND1 of the first arm of the robot 20 to grasp the electric driver T based on the detected position. After causing the grasping unit HND1 of the first arm to grasp the electric driver T, the control device 30 moves the electric driver T to a predetermined position state determination position for determining the position state of the tip SC of the electric driver T, by the grasping unit HND1. The control device 30 controls the robot 20 so that a still image of a range including the electric driver T grasped by the grasping unit HND1 and the grasping unit HND1 is obtained by performing the imaging as the second movingly-captured image by the second movable imaging unit 22 of the second arm.

The control device 30 detects the position of the grasping unit HND1 and the position of the tip SC of the electric driver T based on the second movingly-captured image. The control device 30 determines the position state of the electric driver T based on the detected position of the grasping unit HND1 and the position of the tip SC of the electric driver T. As a result of the determination, when it is determined that the position state of the electric driver T is the appropriate position state or when it is determined that the position state of the electric driver T is not the appropriate position state and a difference between the appropriate position and the inappropriate position is in the predetermined range, the control device 30 controls the robot 20 so that the robot fits the screw O to the tip SC of the electric driver T from the material supply device SB by the electric driver T. As a result of the determination, when it is determined that the position state of the electric driver T is not the appropriate position state and a difference between the appropriate position and the inappropriate position is not in the predetermined range, the control device 30 controls the robot 20 so that the robot returns the electric driver T to the initial position and grasps the electric driver T again.

Hereinafter, regarding the control device 30, as a result of the determination, a case where it is determined that the position state of the electric driver T is the appropriate position state, or a case where it is determined that the position state of the electric driver T is not the appropriate position state and a difference between the appropriate position and the inappropriate position is in a predetermined range will be described. The control device 30 detects the position of the material supply device SB based on the stereo captured image which is obtained by performing the imaging by the imaging unit 10. The control device 30 may have a configuration of detecting the position of the material supply device SB based on any one of the first fixedly-captured image and the second fixedly-captured image, instead of a configuration of detecting the position of the material supply device SB based on the stereo captured image. In addition, the control device 30 may have a configuration of detecting the position of the material supply device SB based on one or both of the first movingly-captured image and the second movingly-captured image obtained by imaging the operation area.

The control device 30 controls the robot 20 so that the robot fits the screw O to the tip SC of the electric driver T grasped by the grasping unit HND1 of the first arm, based on the detected position of the material supply device SB. After the screw O is fit by the tip SC of the electric driver T, the control device 30 controls the robot 20 so that the still image of the range including the electric driver T grasped by the grasping unit HND1 and the screw O adsorbed to the tip SC of the electric driver T is obtained by performing the imaging as the second movingly-captured image by the second movable imaging unit 22 of the second arm.

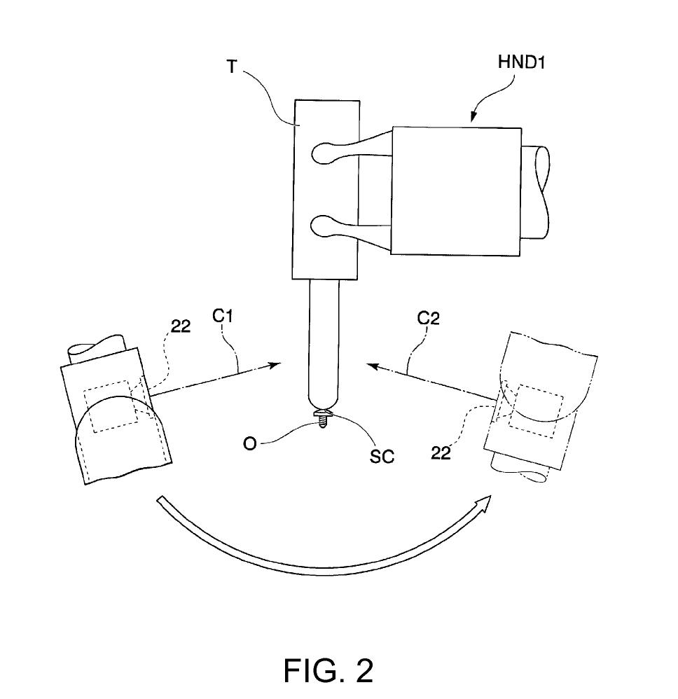

Herein, the capturing of the second movingly-captured image by the second movable imaging unit 22 will be described with reference to FIG. 2. FIG. 2 is a diagram showing an example of a state where the second movingly-captured image is obtained by performing the imaging by the second movable imaging unit 22. After the screw O is fit by the tip SC of the electric driver T, the control device 30 controls the robot 20 so that the electric driver T having the screw O fit to the tip SC thereof is moved to the predetermined imaging position by the grasping unit HND1. The control device 30 images the range including the electric driver T grasped by the grasping unit HND1 and the screw O adsorbed to the tip SC of the electric driver T by the second movable imaging unit 22 in two directions of a first direction C1 and a second direction C2 different from the first direction C1.

As described above, by capturing the second movingly-captured image in two directions of the first direction C1 and the second direction C2, the control device 30 can suppress erroneous determination for the state where the fitting error has occurred, as the state where the fitting error has not occurred. The control device 30 may have a configuration of imaging the second movingly-captured image in three or more directions including the first direction C1 and the second direction C2, or may have a configuration of imaging the second movingly-captured image only in any one direction of the first direction C1 and the second direction C2. In addition, the control device 30 may have a configuration of fixing the position of the second arm (that is, the second movable imaging unit 22) and capturing the second movingly-captured image in one or both directions of the first direction C1 and the second direction C2 by the second movable imaging unit 22 by moving the first arm (that is, moving the electric driver T).

In the embodiment, the control device 30 has a configuration of detecting the position of the grasping unit HND1 and the position of the tip SC of the electric driver T based on the second movingly-captured image obtained by imaging the range including the electric driver T and the grasping unit HND1 in the first direction, when determining the position state of the electric driver T based on the second movingly-captured image which is obtained by performing the imaging by the second movable imaging unit 22, but instead of this, in the same manner as in a case of determining the fitting state described in FIG. 2, the control device may have a configuration of causing the second movable imaging unit 22 to capture the second movingly-captured image of the range including the electric driver T and the grasping unit HND1 in two or more directions, and detecting the position of the grasping unit HND1 and the position of the tip SC of the electric driver T based on the second movingly-captured image obtained by performing the imaging in two or more directions.

The control device 30 determines whether or not the screw O is fit in the appropriate state by the tip SC of the electric driver T, based on the second movingly-captured image (in this example, two second movingly-captured images obtained one after another by imaging in two directions). As a result of the determination, when it is determined that the screw O is not fit in the appropriate state, the control device 30 controls the robot 20 so that the robot performs the operation based on the fitting error.

The control device 30 may have a configuration of detecting the position of the grasping unit HND1 and the position of the tip SC of the electric driver T, based on the stereo captured image which is obtained by performing the imaging by the imaging unit 10 (or any one of the first fixedly-captured image and the second fixedly-captured image). In this case, in the control device 30, the position state determination position to which the electric driver T is moved by the grasping unit HND1, after the electric driver T is grasped by the grasping unit HND1, is a position where the range including the electric driver T grasped by the grasping unit HND1 and the grasping unit HND1 can be imaged by the imaging unit 10.

The control device 30 may have a configuration of determining whether or not the screw O is fit to the tip SC of the electric driver T in the appropriate state, based on the stereo captured image which is obtained by performing the imaging by the imaging unit 10. In this case, in the control device 30, the predetermined imaging position to which the electric driver T having the screw O fit to the tip SC thereof is moved by the grasping unit HND1, after the screw O is fit to the tip SC of the electric driver T, is a position where the range including the electric driver T grasped by the grasping unit HND1 and the screw O adsorbed to the tip SC of the electric driver T can be imaged by the imaging unit 10.

Meanwhile, as a result of the determination, when it is determined that the screw O is fit in the appropriate state, for example, the control device 30 controls the robot 20 so that the robot moves the screw O fit to the tip SC of the electric driver T to the predetermined screw fastening position and performs the screw fastening. The control device 30, for example, has a configuration for performing an operation of fitting the screw O to the electric driver T from the material supply device SB so as not to break the material supply device SB or the screw O by a visual servo or compliant motion control, or an operation such as the screw fastening of the screw O, but instead of this, the control device may have a configuration for not performing the compliant motion control or may have a configuration for controlling the robot 20 by any methods other than the visual servo. One or both of the grasping unit HND1 and the grasping unit HND2 is an example of the hand.

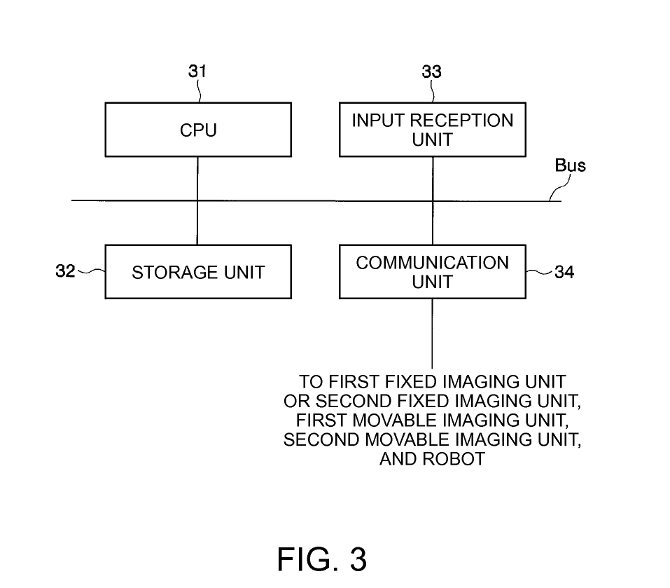

Next, a hardware configuration of the control device 30 will be described with reference to FIG. 3. FIG. 3 is a diagram showing an example of the hardware configuration of the control device 30. The control device 30, for example, includes a central processing unit (CPU) 31, a storage unit 32, an input reception unit 33, and a communication unit 34, and communicates with the robot 20 through the communication unit 34. The constituent elements are connected to each other through a bus so as to communicate with each other. The CPU 31 executes various programs stored in the storage unit 32.

The storage unit 32, for example, includes a hard disk drive (HDD) or solid state drive (SSD), an electrically erasable programmable read-only memory (EEPROM), a read-only memory (ROM), a random access memory (RAM), or the like, and stores various information items or images and programs to be processed by the control device 30. The storage unit 32 may be an external storage device connected by a digital input and output port of a USB or the like, instead of a unit built into the control device 30.

The input reception unit 33 is, for example, a keyboard or a mouse, a touch pad, and other input devices. The input reception unit 33 may function as a display unit and may be configured as a touch panel.

The communication unit 34 is, for example, configured to include a digital input and output port of a USB or Ethernet (registered trademark) port.

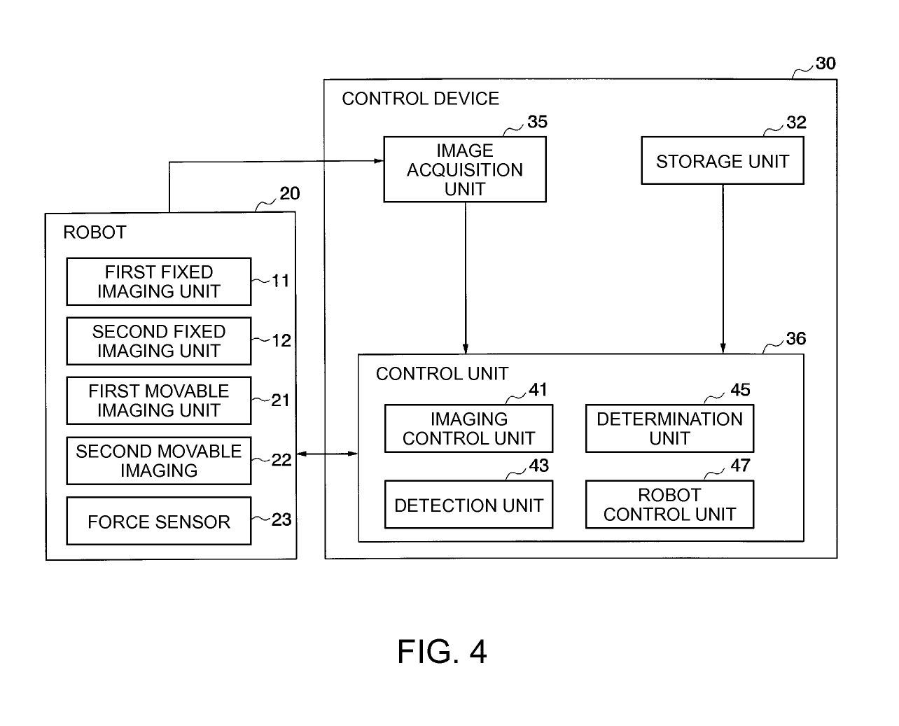

Next, a functional configuration of the control device 30 will be described with reference to FIG. 4. FIG. 4 is a diagram showing an example of a functional configuration of the control device 30. The control device 30 includes the storage unit 32, an image acquisition unit 35, and a control unit 36. Some or all of the functional units included in the control unit 36 are realized by executing various programs stored in the storage unit 32 by the CPU 31, for example. Some or all of the functional units may be hardware functional units such as large scale integration (LSI) or an application specific integrated circuit (ASIC).

The image acquisition unit 35 acquires the stereo captured image which is obtained by performing the imaging by the imaging unit 10 from the robot 20. The image acquisition unit 35 outputs the acquired stereo captured image to the control unit 36. The image acquisition unit 35 acquires the first movingly-captured image which is obtained by performing the imaging by the first movable imaging unit 21 from the robot 20. The image acquisition unit 35 outputs the acquired first movingly-captured image to the control unit 36. The image acquisition unit 35 acquires the second movingly-captured image which is obtained by performing the imaging by the second movable imaging unit 22 from the robot 20. The image acquisition unit 35 outputs the acquired second movingly-captured image to the control unit 36.

The control unit 36 includes an imaging control unit 41, a detection unit 43, a determination unit 45, and a robot control unit 47.

The imaging control unit 41 controls the imaging unit 10 so that the imaging unit captures the stereo captured image. More specifically, the imaging control unit 41 controls the first fixed imaging unit 11 so that the first fixed imaging unit captures the first fixedly-captured image, and controls the second fixed imaging unit 12 so that the second fixed imaging unit captures the second fixedly-captured image. The imaging control unit 41 controls the first movable imaging unit 21 so that the first movable imaging unit captures the first movingly-captured image. The imaging control unit 41 controls the second movable imaging unit 22 so that the second movable imaging unit captures the second movingly-captured image.

The detection unit 43 detects the position where the electric driver T is installed, based on the stereo captured image acquired by the image acquisition unit 35. More specifically, the detection unit 43 reads the image (captured image or computer graphics (CG)) of the electric driver T stored in the storage unit 32 and detects the position of the electric driver T from the stereo captured image by pattern matching based on the read image of the electric driver T.

The detection unit 43 detects the position of the grasping unit HND1 or the grasping unit HND2 and the position of the tip SC of the electric driver T, based on the first movingly-captured image or the second movingly-captured image acquired by the image acquisition unit 35. More specifically, the detection unit 43 reads the image (captured image or computer graphics (CG)) of the grasping unit HND1 or the grasping unit HND2 and the electric driver T stored in the storage unit 32 and detects the position of the grasping unit HND1 or the grasping unit HND2 and the position of the tip SC of the electric driver T by pattern matching based on the image. Instead of the configuration of detecting the position of the grasping unit HND1 or the grasping unit HND2 based on the first movingly-captured image or the second movingly-captured image and the position of the tip SC of the electric driver T, the detection unit 43 may have a configuration of detecting the position of the grasping unit HND1 or the grasping unit HND2 and the position of the tip SC of the electric driver T, based on one or both of the first fixedly-captured image and the second fixedly-captured image.

The detection unit 43 detects the position of the material supply device SB, based on the stereo captured image acquired by the image acquisition unit 35. More specifically, the detection unit 43 reads the image (captured image or CG) of the material supply device SB stored by the storage unit 32 and detects the position of the material supply device SB from the stereo captured image by pattern matching based on the read image of the material supply device SB. Instead of the configuration of detecting the position of the material supply device SB based on the stereo captured image, the detection unit 43 may have a configuration of detecting the position of the material supply device SB based on any one of the first fixedly-captured image and the second fixedly-captured image. The detection unit 43 may have a configuration of detecting the position of the material supply device SB based on one or both of the first movingly-captured image and the second movingly-captured image obtained by imaging the operation area.

Instead of the configuration of detecting the position of the electric driver T or the material supply device SB by pattern matching, the detection unit 43 may have, for example, a configuration of detecting the material supply device SB by other methods such as a configuration for reading the position of the electric driver T or the material supply device SB previously stored in the storage unit 32, a configuration of detecting the position of the electric driver T or the material supply device SB by markers attached to the material supply device SB from the stereo captured image, or a configuration of detecting the electric driver T and the material supply device SB by different methods.

The detection unit 43 reads screw position information which is information stored by the storage unit 32 and shows a relative position from the position of the material supply device SB to the screw O and detects (calculates) the position of the screw O based on the read screw position information. Instead of the configuration of detecting the position of the material supply device SB and detecting the position of the screw O based on the detected position of the material supply device SB, the detection unit 43 may have a configuration of detecting the screw O by pattern matching from the stereo captured image without using the position of the material supply device SB. In this case, the detection unit 43 detects the position of the screw O from the stereo captured image, without ascertaining the position of the material supply device SB.

When the electric driver T is grasped by the grasping unit HND1, the determination unit 45 determines the position state of the electric driver T, based on the position of the grasping unit HND1 and the position of the tip SC of the electric driver T which are detected by the detection unit 43. When the electric driver T is grasped by the grasping unit HND2, the determination unit 45 determines the position state of the electric driver T, based on the position of the grasping unit HND2 and the position of the tip SC of the electric driver T which are detected by the detection unit 43. When it is determined that the position state of the electric driver T is not the appropriate position state by the determination of the position state of the electric driver T, the determination unit 45 determines whether or not a difference between the appropriate position and the inappropriate position is in the predetermined range.

When the electric driver T is grasped by the grasping unit HND2, the determination unit 45 determines whether or not the screw O is fit to the tip SC of the electric driver T in the appropriate state (that is, whether or not a fitting error has occurred), based on the first movingly-captured image which is obtained by performing the imaging in the first direction C1 and the first movingly-captured image which is obtained by performing the imaging in the second direction C2. When the electric driver T is grasped by the grasping unit HND1 as shown in FIG. 1, the determination unit 45 determines whether or not a fitting error has occurred, based on the second movingly-captured image which is obtained by performing the imaging in the first direction C1 and the second movingly-captured image which is obtained by performing the imaging in the second direction C2.

The robot control unit 47 controls the robot 20 so that the grasping unit HND1 or the grasping unit HND2 grasps the electric driver T by the visual servo, for example, based on the position where the electric driver T is installed, which is detected by the detection unit 43. After the electric driver T is grasped by the grasping unit HND1 or the grasping unit HND2, the robot control unit 47 controls the robot 20 so that the electric driver T is moved to the position state determination position by the grasping unit HND1 or the grasping unit HND2.

As a result of the determination, when it is determined that the position state of the electric driver T is the appropriate position state or when it is determined that the position state of the electric driver T is not the appropriate position state and a difference between the appropriate position and the inappropriate position is in the predetermined range, the robot control unit 47 controls the robot 20 so that the robot fits the screw O to the tip SC of the electric driver T from the material supply device SB by the electric driver T. As a result of the determination, when it is determined that the position state of the electric driver T is not the appropriate position state and a difference between the appropriate position and the inappropriate position is not in the predetermined range, the robot control unit 47 controls the robot 20 so that the robot returns the electric driver T to the initial position and grasps the electric driver T again.

The robot control unit 47 controls the robot 20 so that the screw O is fit to the tip SC of the electric driver T by adsorbing the screw O to the tip SC of the electric driver T by the visual servo, for example, based on the position of the screw O detected by the detection unit 43. After the screw O is fit to the tip SC of the electric driver T, the robot control unit 47 controls the robot 20 so that the electric driver T is moved to the predetermined imaging position by moving the arm (first arm or second arm) grasping the electric driver T.

When it is determined that a fitting error has occurred, the robot control unit 47 controls the robot 20 so that the operation is performed based on the fitting error. When it is determined that a fitting error has not occurred, the robot control unit 47 controls the robot 20 so that the robot moves the screw O fit to the electric driver T to the predetermined screw fastening position and performs the screw fastening, for example.

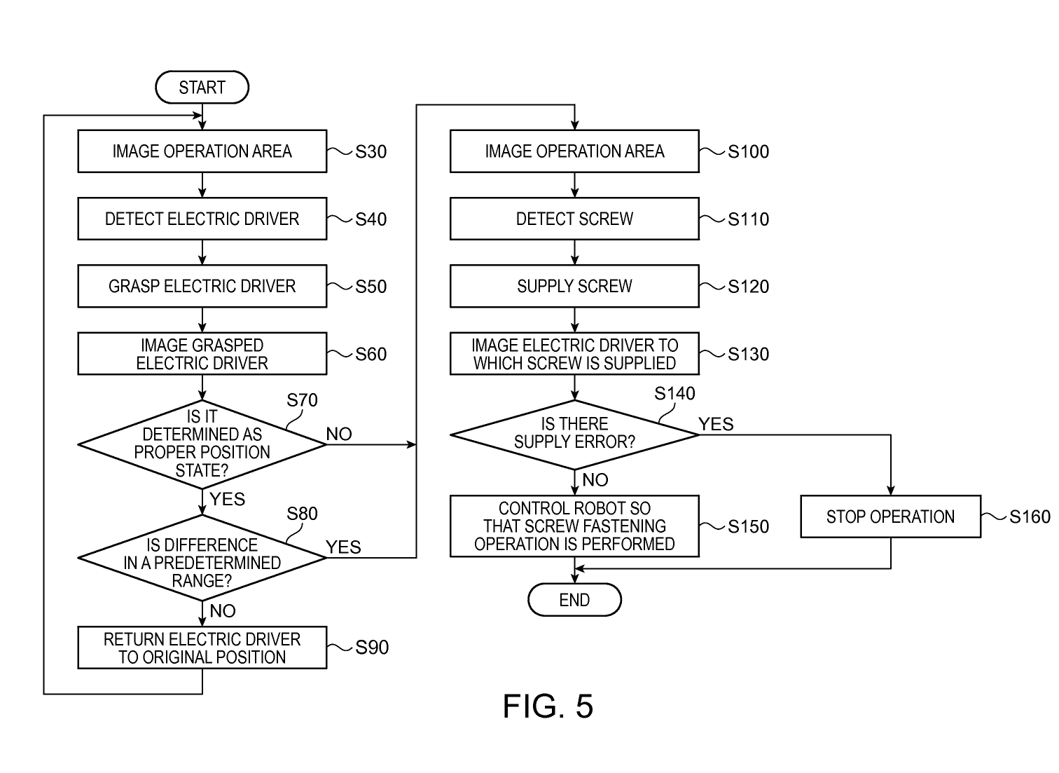

Hereinafter, a process in which the control device 30 causes the robot 20 to grasp an electric driver T to a process of performing the operation based on the determination result showing whether or not a fitting error has occurred will be described with reference to FIG. 5. FIG. 5 is a flowchart showing a flow from the process in which the control device 30 causes the robot 20 to grasp the electric driver T to the process of performing the operation based on the determination result showing whether or not a fitting error has occurred.

First, the imaging control unit 41 controls the imaging unit 10 so that the stereo captured image of the operation area is obtained by performing the imaging. The control unit 36 acquires the stereo captured image obtained by performing the imaging by the imaging unit 10, by the image acquisition unit 35 (Step S30). Then, the detection unit 43 detects the position where the electric driver T is installed by the pattern matching based on the stereo captured image acquired in Step S30 (Step S40). At that time, the detection unit 43 reads an image of the electric driver T used in the pattern matching which is an image stored in the storage unit 32, and performs the pattern matching by using the read image.

Next, the robot control unit 47 controls the robot 20 so that the predetermined grasping position on the electric driver T is grasped by the grasping unit HND1 by moving the first arm, based on the position where the electric driver T is installed, which is detected in Step S40 (Step S50). Then, the robot control unit 47 controls the robot 20 so that the electric driver T grasped by the grasping unit HND1 in Step S50 is moved to the position state determination position by moving the first arm. The robot control unit 47 moves the second movable imaging unit 22 to the position where the range including the electric driver T and the grasping unit HND1 can be imaged by moving the second arm. The imaging control unit 41 images the range including the electric driver T and the grasping unit HND1 as the second movingly-captured image by the second movable imaging unit 22. The control unit 36 acquires the second movingly-captured image obtained by performing the imaging by the second movable imaging unit 22, by the image acquisition unit 35 (Step S60).

Then, the detection unit 43 detects the position of the grasping unit HND1 and the position of the tip SC of the electric driver T, based on the second movingly-captured image obtained by performing the imaging in Step S60. The determination unit 45 determines whether or not the position state of the electric driver T is the appropriate position state, based on the position of the grasping unit HND1 and the position of the tip SC of the electric driver T which are detected by the detection unit 43 (Step S70). When it is determined that the position state of the electric driver T is the appropriate position state (Step S70-Yes), the imaging control unit 41 controls the imaging unit 10 so that the stereo captured image of the operation area is obtained by performing the imaging and the control unit 36 acquires the stereo captured image obtained by performing the imaging by the imaging unit 10, by the image acquisition unit 35 (Step S100). Meanwhile, when it is determined that the position state of the electric driver T is not the appropriate position state (Step S70-No), the determination unit 45 determines whether or not a difference between the appropriate position and the inappropriate position is in the predetermined range (Step S80).

When it is determined that a difference between the appropriate position and the inappropriate position is not in the predetermined range (Step S80-No), the robot control unit 47 returns the electric driver T to the position before being grasped by the grasping unit HND1 in Step S50 and grasps the electric driver T again by returning to Step S30. Meanwhile, when it is determined that a difference between the appropriate position and the inappropriate position is in the predetermined range (Step S80-Yes), the process proceeds to Step S100, the imaging control unit 41 controls the imaging unit 10 so that the stereo captured image of the operation area is obtained by performing the imaging, and the control unit 36 acquires the stereo captured image obtained by performing the imaging by the imaging unit 10, by the image acquisition unit 35.

Next, the detection unit 43 detects the position of the material supply device SB by the pattern matching based on the stereo captured image acquired in Step S100. At that time, the detection unit 43 reads the image of the material supply device SB used in the pattern matching which is the image stored in the storage unit 32 and performs the pattern matching by using the read image.

The detection unit 43 reads the screw position information from the storage unit 32 and detects the position of the screw O (operation member) based on the read screw position information and the detected position of the material supply device SB (Step S110). Next, the robot control unit 47 controls the robot 20 so that the screw O is fit to the tip SC of the electric driver T by moving the first arm, based on the position of the screw O detected in Step S110 (Step S120).

Then, the robot control unit 47 moves the electric driver T having the screw O fit to the tip SC thereof to the predetermined imaging position by moving the first arm of the robot 20. After that, the robot control unit 47 controls the robot 20 so that the second movable imaging unit 22 moves to the position where the second movingly-captured image of the range including the electric driver T is obtained by performing the imaging. The imaging control unit 41 controls the second movable imaging unit 22 so as to capture the second movingly-captured image (Step S130).

More specifically, after the electric driver T is moved to the predetermined imaging position, the robot control unit 47 controls the second arm of the robot 20 so that the second movable imaging unit 22 is moved to the position where the range including the electric driver T can be imaged in the first direction C1. After the second movable imaging unit 22 is moved to the position where the range including the electric driver T can be imaged in the first direction C1, the imaging control unit 41 controls the second movable imaging unit 22 so that the first sheet of the second movingly-captured image is obtained by performing the imaging.

After the first sheet of the second movingly-captured image is obtained by performing the imaging, the robot control unit 47 controls the second arm of the robot 20 so that the second movable imaging unit 22 is moved to the position where the range including the electric driver T can be imaged in the second direction C2. After the second movable imaging unit 22 is moved to the position where the range including the electric driver T can be imaged in the second direction C2, the imaging control unit 41 controls the second movable imaging unit 22 so that the second sheet of the second movingly-captured image is obtained by performing the imaging.

Next, the determination unit 45 determines whether or not a fitting error has occurred, based on the first and second sheets of the second movingly-captured image obtained by performing the imaging in Step S130 (Step S140). More specifically, the determination unit 45 performs the determination by performing the pattern matching based on the image (captured image or CG) of the state where the screw O is fit to the tip SC of the electric driver T in the appropriate state from the storage unit 32.

Regarding any one of the first sheet of the second movingly-captured image and the second sheet of the second movingly-captured image, as a result of the determination by the pattern matching, when it is determined that the screw O is not fit to the tip SC of the electric driver T in the appropriate state (Step S140-Yes), the robot control unit 47 determines that a fitting error has occurred and controls the robot 20 so as to perform the operation based on the fitting error (Step S160). In this example, the control is control of moving the electric driver T to the predetermined standby position and then stopping the operation.

Meanwhile, regarding both of the first sheet of the second movingly-captured image and the second sheet of the second movingly-captured image, as a result of the determination by the pattern matching, when it is determined that the screw O is fit to the tip SC of the electric driver T in the appropriate state (Step S140-No), the robot control unit 47 determines that the fitting error has not occurred and controls the robot 20 so that the screw O fit to the electric driver T is moved to the predetermined screw fastening position and the screw fastening is performed (Step S150).

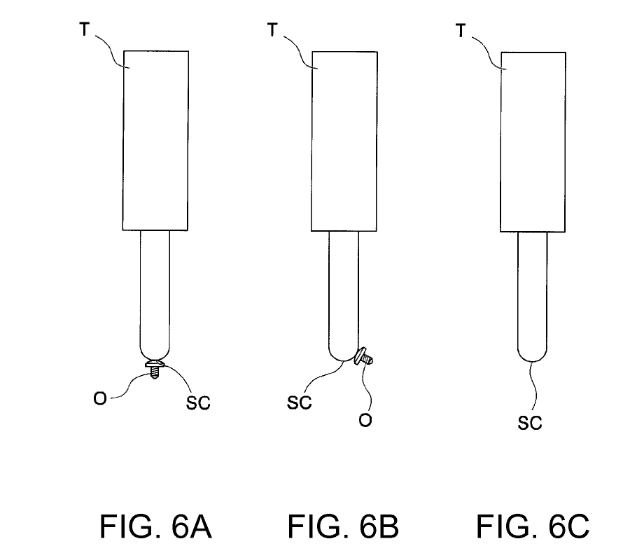

Herein, the fitting error will be described with reference to FIGS. 6A to 6C. FIGS. 6A to 6C are diagrams showing examples of a state where the fitting error has not occurred and a state where the fitting error has occurred. FIG. 6A shows an example of the state where the fitting error has not occurred. As shown in FIG. 6A, the state where the fitting error has not occurred (that is, the state where the screw O fit to the tip SC of the electric driver T is suitable), is a state where a screw head of the screw O is fit to the tip SC of the electric driver T in a state where the screw fastening can be performed by the tip SC. More specifically, the state thereof fit in a state where the screw fastening can be performed, is a state where the fitting is performed so that the center axis of the electric driver T in the longitudinal direction and the center axis of the screw O in a traveling direction at the time of the screw fastening coincide with each other.

Unlike the state shown in FIG. 6A, FIG. 6B shows an example of the state where the fitting error has occurred. In the example shown in FIG. 6B, the screw head of the screw O is not fit to the tip SC so that the screw fastening can be performed by the tip SC of the electric driver T, and the center axis of the screw O at the time of the screw fastening does not coincide with the center axis of the electric driver T in the longitudinal direction. This case of an unsuitable state is a case where it is difficult for the electric driver T to perform the screw fastening of the screw O.

FIG. 6C shows another example of the state where the fitting error has occurred. The state shown in FIG. 6C is a state where the screw O is not fit to the tip SC of the electric driver T. This shows that the fitting of the screw O to the tip SC of the electric driver T has failed. In a case of the state shown in FIG. 6A, the control unit 36 controls the robot 20 so that the screw fastening of the screw O is performed in the predetermined screw fastening position, and in a case of the state shown in FIG. 6B or FIG. 6C, the control unit controls the robot 20 so that the operation based on the fitting error is performed.

The control unit 36 may have a configuration of causing the robot 20 to perform the operation based on different fitting errors regarding type of fitting error occurring, when a fitting error has occurred. For example, when the fitting error of the state shown in FIG. 6B has occurred, the control unit 36 may cause the robot 20 to perform a first operation based on the fitting error, and when the fitting error of the state shown in FIG. 6C has occurred, the control unit may cause the robot 20 to perform a second operation based on the fitting error.

The determination unit 45 determines whether or not the screw O is fit to the tip SC of the electric driver T in the suitable state and determines the case of an unsuitable state as the fitting error, but instead of this, the determination unit may have a configuration of determining whether or not the screw O is fit to the tip SC of the electric driver T in any state among the plurality of states. In this case, the state showing the fitting error may be included or not be included in the plurality of states.

As described above, the robot system 1 according to the embodiment grasps the electric driver T by the grasping unit HND1 or the grasping unit HND2 and detects the position of the tip SC of the electric driver T based on the second movingly-captured image including the electric driver T. Accordingly, the robot system 1 can determine the success or failure regarding the grasping of the electric driver T.

The robot system 1 determines whether or not the position state of the electric driver T is the appropriate position state based on the detected position of the tip SC of the electric driver T. Accordingly, the robot system 1 can realize the operation performed according to the position state.

The robot system 1 fits the screw O to the electric driver T and determines the fitting state of the screw O based on the captured image including the screw O. Accordingly, the robot system 1 can realize the operation performed according to the fitting state of the screw O.

When it is determined that the position state is the appropriate position state, the robot system 1 fits the screw O to the electric driver T and determines the fitting state. Accordingly, the robot system 1 can perform the fitting as the next operation, while preventing an error occurring when grasping the electric driver T, for example.

When it is determined that the position state is not the appropriate position state and the deviation from the appropriate position state (that is, a difference between the appropriate position and the inappropriate position) is in the predetermined range, the robot system 1 fits the screw O to the electric driver T and determines the fitting state. Accordingly, the robot system 1 can perform the fitting as the next operation, while suppressing the range of the error occurring when grasping the electric driver T in the predetermined range, for example.

When it is determined that the position state is not the appropriate position state and the deviation from the appropriate position state is not in the predetermined range, the robot system 1 grasps the electric driver T again. Accordingly, when the error occurring when grasping the electric driver T is great, the robot system 1 can perform the fitting as the next operation, after grasping the electric driver T again, for example.

The robot system 1 determines whether or not the screw O is fit in the suitable state. Accordingly, the robot can perform different operations in a case where the screw O is fit in the suitable state and in a case where the screw is not fit in the suitable state.

The screw O is fit to the tip SC of the electric driver T by a magnetic force on the tip SC of the electric driver T, and the robot system 1 determines the fitting state thereof. Accordingly, the robot system 1 can perform the operation according to the fitting state of the screw O by the magnetic force on the tip SC of the electric driver T.

The robot system 1 determines the fitting state of the screw O based on the second movingly-captured image obtained by performing the imaging in each direction of two or more directions. Accordingly, the robot system 1 can prevent the erroneous determination of the fitting state of the screw O.

The robot system 1 determines the position state of the electric driver T based on the second movingly-captured image by the pattern matching. Accordingly, the robot system 1 can determine the position state of the electric driver T using the pattern matching.

The robot system 1 determines the fitting state of the screw O based on the second movingly-captured image by the pattern matching. Accordingly, the robot system 1 can determine the fitting state of the screw O using the pattern matching.

The robot system 1 moves the grasping unit HND1 or the grasping unit HND2 according to the result of determination of the position state. Accordingly, the robot system 1 can realize the operation of the grasping unit HND1 or the grasping unit HND2 according to the position state of the electric driver T.

The robot system 1 moves the grasping unit HND1 or the grasping unit HND2 according to the result of determination of the fitting state of the screw O. Accordingly, the robot system 1 can realize the operation of the grasping unit HND1 or the grasping unit HND2 according to the fitting state of the screw O.

When it is determined that the screw O is not fit in the suitable state, the robot system 1 stops the operation of the grasping unit HND1 or the grasping unit HND2. Accordingly, in the robot system 1, it is not necessary for a user to stop the operation of the grasping unit HND1 or the grasping unit HND2, even when the fitting of the screw O fails, for example.

In the embodiment, the robot system 1 has a configuration of detecting the position of the tip SC of the electric driver T based on the first movingly-captured image and the second movingly-captured image, but instead of this, the robot system may have a configuration of irradiating the electric driver T with laser and detecting the position of the tip SC of the electric driver T based on the position of the laser reflected from the tip SC of the electric driver T. In this case, the robot system 1 includes a laser irradiation unit and a reflected laser detection unit which detects the reflected laser, and the position of the reflected laser and the position of the tip SC of the electric driver T are mapped by calibration or the like in advance.

Hereinbefore, the embodiments of the invention have been described with reference to the drawings, but the specific configuration is not limited to the embodiments, and modifications, replacement, and removal may be performed within a range not departing from the gist of the invention.

The program for realizing the functions of arbitrary functional units of the device described above (for example, the control device 30 of the robot system 1) may be recorded in a computer-readable recording medium and may cause a computer system to read and execute the programs. The “computer system” herein includes an operating system (OS) or hardware of peripherals or the like. The “computer-readable recording medium” is a portable medium such as a flexible disk, a magnetooptical disk, a read only memory (ROM), or a compact disk (CD)-ROM, or a recording device such as a hard disk embedded in a computer system. In addition, the “computer-readable recording medium” includes a medium storing a program for a certain time, as a volatile memory (random access memory: RAM) in a computer system which is a server or a client when the program is transmitted through a network such as the Internet or a communication line such as a telephone line.

The program may be transmitted to another computer system through a transmission medium or by a transmitted wave in the transmission medium, from the computer system including the program stored in the recording device and the like. Herein, the “transmission medium” for transmitting the program is a medium having a function of transmitting the information such as a network (communication net) such as the Internet or a communication line such as a telephone line.

The program may be a program for realizing some of the functions described above. The program may be a so-called differential file (differential program) which can realize the functions described above in combination with a program which is already recorded in the computer system.

The entire disclosure of Japanese Patent Application No. 2014-114286, filed Jun. 2, 2014 is expressly incorporated by reference herein.

What is claimed is:

1. A robot comprising:
hands; and
a control unit which controls the hands,
wherein the control unit grasps a target to be grasped by using the hands and detects a position of the target to be grasped, based on a captured image including the target to be grasped.

2. The robot according to claim 1,
wherein the control unit determines whether or not a position state showing a relative position between the position of the target to be grasped and the position of the hand is a predetermined position state, based on the detected position of the target to be grasped.

3. The robot according to claim 2,
wherein the control unit fits an operation member to the target to be grasped and determines a fitting state of the operation member based on a captured image including the operation member.

4. The robot according to claim 3,
wherein the control unit performs the fitting and determines the fitting state, when it is determined that the position state is the predetermined position state.

5. The robot according to claim 3,
wherein the control unit performs the fitting and determines the fitting state, when it is determined that the position state is not the predetermined position state and it is determined that the deviation from the predetermined position state is in a predetermined range.

6. The robot according to claim 5,
wherein the control unit grasps the target to be grasped, again, when it is determined that the position state is not the predetermined position state and it is determined that the deviation from the predetermined position state is not in a predetermined range.

7. The robot according to claim 3,
wherein the control unit determines whether or not the operation member is fit in the predetermined fitting state.

8. The robot according to claim 3,
wherein the operation member is magnetically attached to a tip of the target to be grasped by a magnetic force.

9. The robot according to claim 3,
wherein the control unit determines the fitting state of the operation member based on the captured image obtained by performing the imaging in each direction from two or more directions.

10. The robot according to claim 3,
wherein the control unit determines the position state of the target to be grasped, based on the captured image by pattern matching.

11. The robot according to claim 3,
wherein the control unit determines the fitting state of the operation member based on the captured image by pattern matching.

12. The robot according to claim 3,
wherein the control unit moves the hand according to the result of determination of the position state.

13. The robot according to claim 3,
wherein the control unit moves the hand according to the result of determination of the fitting state.

14. The robot according to claim 7,
wherein the control unit stops the operation of the hand, when it is determined that the operation member is not fit in the predetermined fitting state.

15. A robot system comprising:
a robot including hands grasping a target to be grasped; and
an imaging unit which captures a captured image including the target to be grasped,
wherein the robot grasps the target to be grasped by using the hand and detects a position of the target to be grasped based on the captured image including the target to be grasped.

16. A control method of causing a robot including hands grasping a target to be grasped, to:
grasp the target to be grasped by using the hand and detect a position of the target to be grasped based on a captured image including the target to be grasped.
